(19) United States
(12) Patent Application Publication
(10) Pub. No.: US 2022/0327498 A1
(43) Pub. Date: Oct. 13, 2022

(54) INTELLIGENT HARDWARE DELIVERY FOR ON-PREMISES HARDWARE AS A SERVICE

(71) Applicant: Dell Products L.P., Round Rock, TX (US)

(72) Inventors: Shibi Panikkar, Bangalore (IN); Sisir Samanta, Bangalore (IN)

(21) Appl. No.: 17/227,788

(22) Filed: Apr. 12, 2021

(51) Int. Cl. G06Q 10/00; G06N 5/02

(52) U.S. Cl. CPC G06Q 10/20; G06N 5/02; G06F 9/541

(57) ABSTRACT

Intelligent hardware delivery for on-premises hardware as a service is described herein. A method as described herein can include classifying data storage systems into a system group based on a common characteristic of the respective systems; generating predicted storage capacity data representative of respective predicted available storage capacities of the respective systems over a first time period based on storage usage data obtained from the respective systems over a second, earlier time period; receiving, from a manufacturing system, manufacturing schedule data representative of a manufacturing schedule for new storage devices; receiving, from the respective systems, maintenance schedule data representative of respective defined maintenance windows for the respective systems; and generating storage expansion schedule data representative of a schedule for addition of the new storage devices to the respective systems, e.g., by correlating the predicted storage capacity data to the manufacturing schedule data and the maintenance schedule data.

### BACKGROUND

Advancements in computer and networking technology have led to rapid growth in the area of cloud computing. A growing number of enterprises are utilizing cloud service deployments to harness the benefits to flexibility and scalability cloud services provide, and this growth is expected to reach virtually all industry segments in the near future. While public cloud deployments have grown significantly, some enterprises prefer to maintain private, on-premises cloud infrastructure, or a hybrid of public and private cloud infrastructure, due to security or other concerns. Because hybrid and private cloud implementations utilize dedicated infrastructure such as clusters, data centers, and the like, it is desirable to implement techniques to facilitate continuous expansion of additional infrastructure on an as-needed basis in a manner that provides improved efficiency and optimizes manufacturing, logistic, and/or other costs while not compromising the overall cloud experience.

The above-described background is merely intended to provide a contextual overview of some current issues, and is not intended to be exhaustive. Other contextual information may become further apparent upon review of the following detailed description.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include a memory that stores executable components and a processor that executes the executable components stored in the memory. The executable components can include a system classification component that classifies respective data storage systems into a group of data storage systems based on a common characteristic of the respective data storage systems of the group of data storage systems, resulting in grouped data storage systems. The executable components can further include a storage modeling component that models respective predicted available storage capacities of the grouped data storage systems over a first time interval based on storage usage data collected from the grouped data storage systems over a second time interval that is before the first time interval, resulting in storage capacity model data representative of a storage capacity model for the grouped data storage systems applicable to the first time interval. The executable components can additionally include an expansion scheduling component that generates storage expansion schedule data representative of a schedule applicable to installing new storage devices at the grouped data storage systems by correlating the storage capacity model data to manufacturing schedule data representative of a manufacturing schedule for the new storage devices as received from a manufacturing system, and generates maintenance schedule data representative of respective defined maintenance schedules for the grouped data storage systems as received from the grouped data storage systems.

In another implementation, a method is described herein. The method can include classifying, by a system operatively coupled to a processor, respective data storage systems into a system group based on a common characteristic of the respective data storage systems of the system group; generating, by the system, predicted storage capacity data representative of respective predicted available storage capacities of the respective data storage systems of the system group over a first time period based on storage usage data obtained from the respective data storage systems of the system group over a second time period that is prior to the first time period; receiving, by the system from a manufacturing system, manufacturing schedule data representative of a manufacturing schedule for new storage devices; receiving, by the system from the respective data storage systems of the system group, maintenance schedule data representative of respective defined maintenance windows for the respective data storage systems of the system group; and generating, by the system, storage expansion schedule data representative of a schedule for addition of the new storage devices to the respective data storage systems of the system group, where generating the storage expansion schedule data includes correlating the predicted storage capacity data to the manufacturing schedule data and the maintenance schedule data.

In an additional implementation, a non-transitory machine-readable medium including computer executable instructions is described herein. The instructions, when executed by a processor of a data storage system, can facilitate performance of operations including assigning respective data storage systems to a system group based on a common property of the respective data storage systems; generating storage availability prediction data representative of predicted available storage capacities of the respective data storage systems over a first time interval based on system usage data obtained from the respective data storage systems over a second time interval that is earlier than the first time interval; and determining system expansion scheduling data representative of a schedule for installation of additional storage devices at the respective data storage systems based on correlating the storage availability prediction data with manufacturing scheduling data representative of a manufacturing schedule for the additional storage devices from a manufacturing system and maintenance schedule data representative of respective system maintenance schedules for the respective data storage systems.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates intelligent hardware delivery for on-premises hardware as a service in accordance with various implementations described herein.

FIG. 2 is a diagram depicting an example operational flow for maintaining hardware provided as a service in accordance with various implementations described herein.

FIG. 3 is a diagram depicting respective supply chain systems associated with respective private cloud systems in accordance with various implementations described herein.

FIG. 4 is a set of diagrams depicting manufacturing schedules for a group of example data centers in accordance with various implementations described herein.

FIG. 5 is a diagram depicting the supply chain systems of FIG. 3 with intelligent hardware management in accordance with various implementations described herein.

FIG. 6 is a diagram depicting types of information that can be utilized by the intelligent hardware as a service (HWaaS) manager of FIG. 5 in accordance with various implementations described herein.

FIG. 7 is a functional block diagram depicting an example model that can be utilized for managing hardware for private or hybrid cloud systems in accordance with various implementations described herein.

FIGS. 8-10 are diagrams depicting example system data that can be utilized for intelligent hardware delivery for on-premises HWaaS in accordance with various implementations described herein.

FIG. 11 is a block diagram of a system that facilitates generation of a storage expansion schedule based on shipping schedule data in accordance with various implementations described herein.

FIG. 12 is a block diagram of a system that facilitates generation of a storage expansion schedule based on system downtime schedule data in accordance with various implementations described herein.

FIG. 13 is a block diagram of a system that facilitates collection of data pertaining to scheduling addition of storage devices to a data storage system in accordance with various implementations described herein.

FIGS. 14-15 are flow diagrams of respective methods that facilitate intelligent hardware delivery for on-premises hardware as a service in accordance with various implementations described herein.

FIG. 16 is a diagram of an example computing environment in which various embodiments described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring certain aspects.

One or more embodiments of the subject application are related to data storage systems, and more particularly, to techniques for managing hardware delivery for a data storage system, e.g., a data storage system employing on-premises HWaaS. In this regard, as a service (aaS) computing models, sometimes referred to in the generic as “X as a service” (XaaS) models, have rapidly risen in popularity in recent years due to their ability to provide large scale cost-effective horizontal scaling for a computing system deployment. For instance, software as a service (SaaS) models enable the use of software that is centrally hosted on a cloud server, thereby providing cost effectiveness and scalability that would be impractical for a locally-hosted solution. Similarly, hardware as a service (HWaaS) models such as infrastructure as a service (IaaS) can enable a computing system to leverage storage, backup, processing, and/or other functionalities hosted by a cloud service, e.g., instead of requiring corresponding infrastructure to be locally owned and operated.

In addition to public cloud computing platforms, there has been an increase in the implementation of private or hybrid cloud platforms, in which some or all of the corresponding cloud infrastructure or other hardware is physically located and hosted on private premises, e.g., property owned and/or controlled by a private system operator. In a HWaaS model, cloud platform hardware that is owned and maintained by a cloud services provider is installed at a system site and provided to a system operator according to a subscription agreement, e.g., with subscription rates based on time of use, resource consumption, and/or other factors. Due to the costs associated with buying and maintaining private cloud platform hardware, HWaaS models can be a desirable alternative to wholly owned infrastructure, e.g., in order to lower costs associated with a private or hybrid cloud implementation.

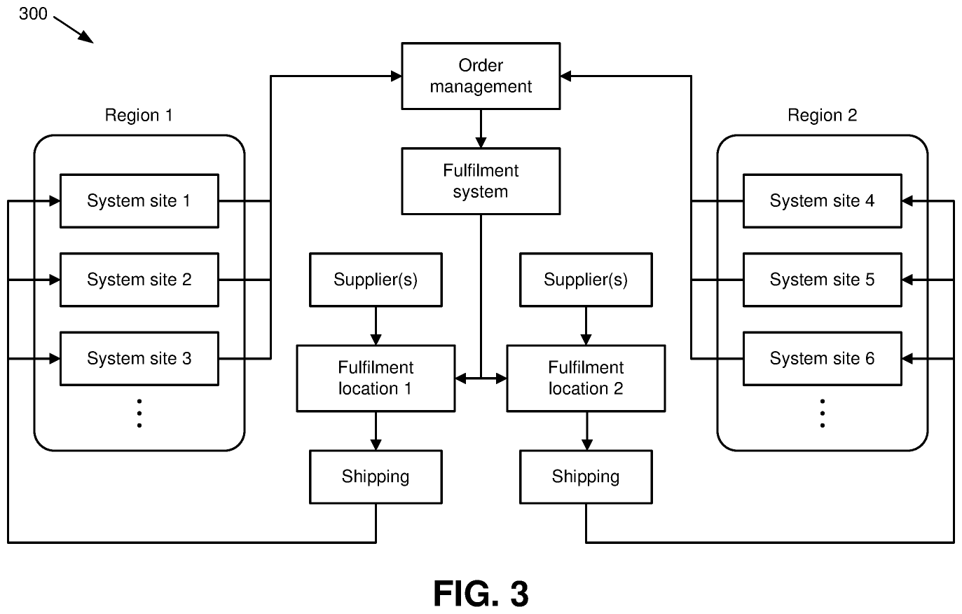

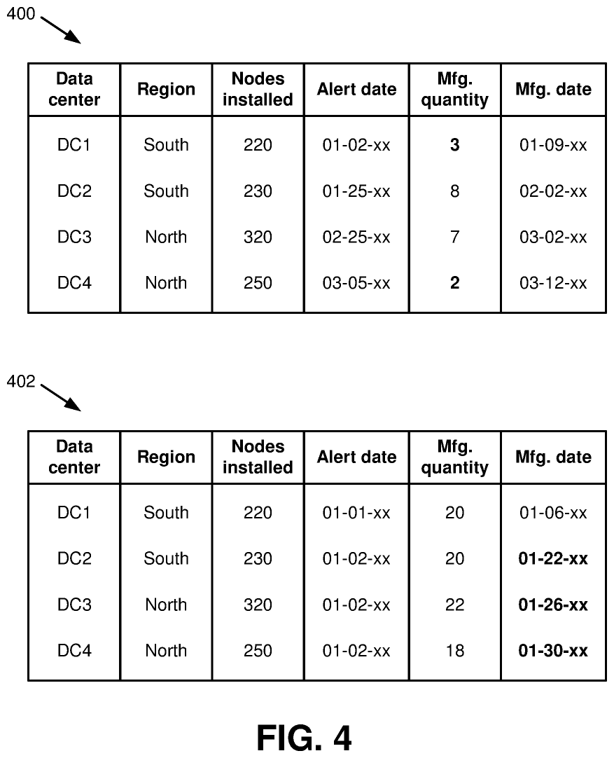

However, the process of manufacturing, shipping and installing private and/or hybrid cloud hardware at respective system sites can introduce significant complexity into the operations of a cloud service provider, and this complexity increases proportionally to the amount of individual systems that are managed by the cloud service provider. For instance, each on-premises cloud system managed by its own cloud service provider can be associated with its own operational data, and these operational data can differ significantly from system to system due to the individual properties of each system. As the number of managed systems increases, manual management of each system, e.g., by a human, can become impractical or impossible to perform in a useful or reasonable timeframe due to the volume of data involved, the nature and extent of computations to be performed, and other factors. This impracticality of manual management, in turn, can result in significant delays and/or disruptions to service, e.g., as will be discussed in further detail below with respect to FIGS. 3-4.

To the furtherance of the above and/or related ends, various implementations described herein provide technical solutions to manage hardware delivery for on-premises HWaaS systems in an intelligent and automated manner. The implementations described below can improve the functionality of on-premises HWaaS systems by providing individual system operators greater flexibility in the use of their computing resources (e.g., storage capacity, processing capability, etc.) and reducing delays associated with system expansion as their system use increases over time. Additionally, by providing automated solutions to hardware delivery management for on-premises cloud deployments that were not previously able to be automated, increased efficiency can also be realized from the perspective of a cloud service provider in terms of time spent on hardware management tasks and/or computing resource usage (e.g., memory usage, power consumption, processing cycles, etc.) associated with the same. Other advantages are also possible.

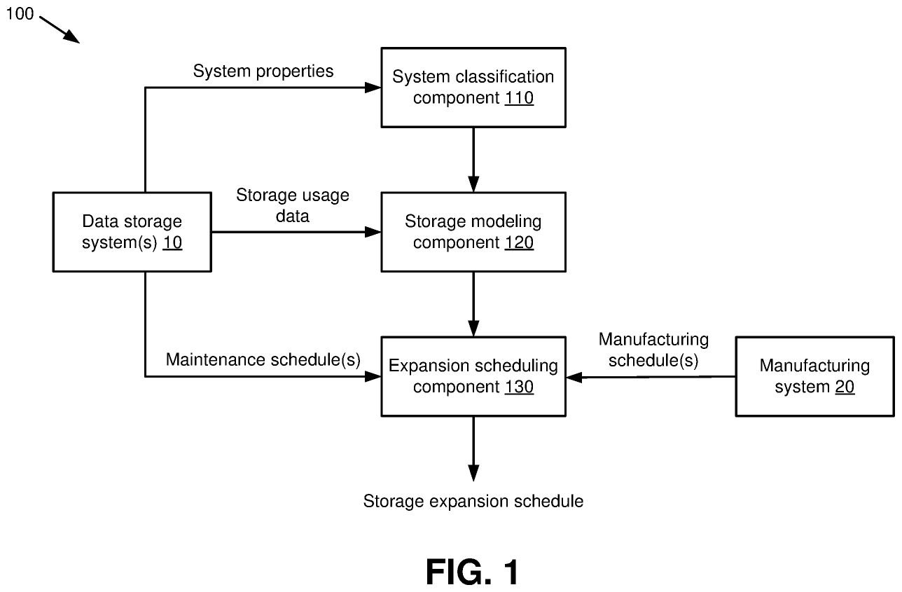

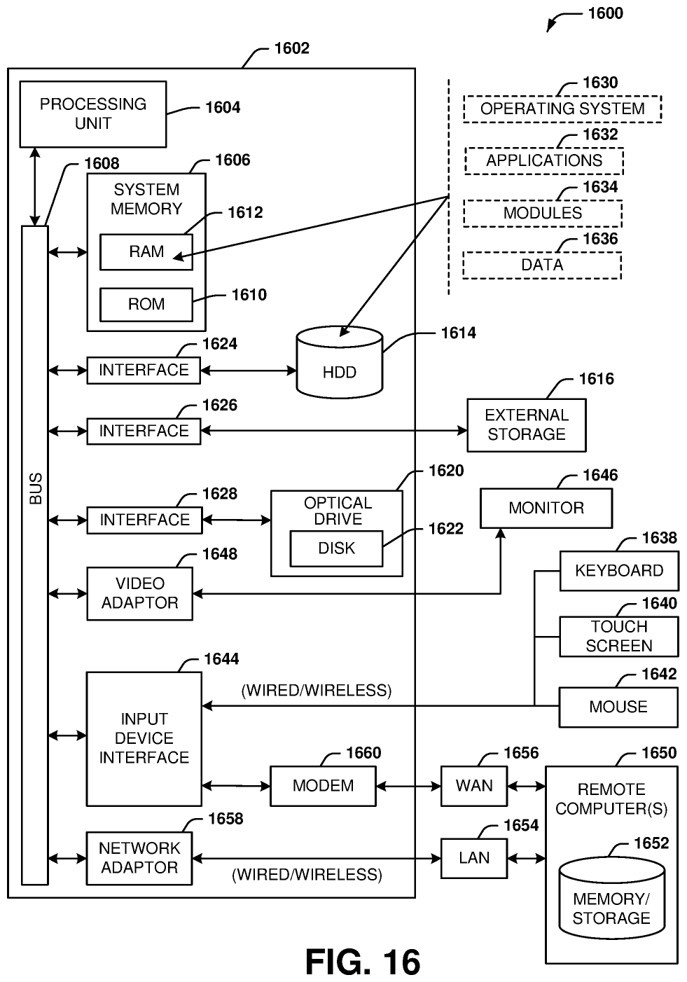

With reference now to the drawings, FIG. 1 illustrates a block diagram of a system 100 that facilitates intelligent hardware delivery for on-premises HWaaS in accordance with various implementations described herein. As shown in FIG. 1, system 100 includes a system classification component 110, a storage modeling component 120, and an expansion scheduling component 130, which can operate as described in further detail below. In an implementation, the components 110, 120, 130 of system 100 can be implemented in hardware, software, or a combination of hardware and software. By way of example, the components 110, 120, 130 can be implemented as computer-executable components, e.g., components stored on a memory and executed by a processor. An example of a computer architecture including a processor and a memory that can be used to implement the components 110, 120, 130, as well as other components as will be described herein, is shown and described in further detail below with respect to FIG. 16. Additionally, it is noted that the components 110, 120, 130 as shown in system 100 could be implemented via a single computing device and/or distributed among multiple computing devices, e.g., computing devices or a computing cluster or distributed computing system that are communicatively coupled via one or more wired or wireless networking technologies.

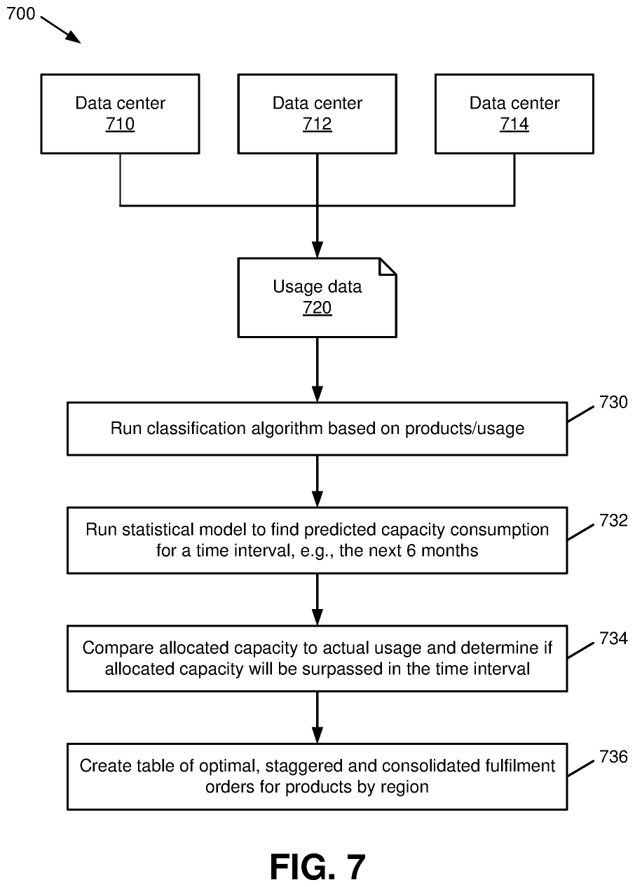

The system classification component 110 shown in system 100 can classify respective computing systems 10, e.g., data storage systems utilizing a hybrid or private cloud architecture, into a group of data storage systems based on a property or characteristic that is common to the data storage systems 10 of the group. For example, the system classification component 110 can assign respective data storage systems 10 to a group in response to determining that the respective data storage systems 10 are located in a common geographical region (e.g., state, country, continent or portion of a continent, etc.), which can enable grouping of the demand from a particular geographical region for a particular device (e.g., computing device, storage device, etc.) associated with the respective data storage systems 10. Also or alternatively, the system classification component 110 can assign respective data storage systems 10 to a group in response to determining that the respective data storage systems 10 have at least one common hardware feature or software feature. Other criteria for grouping respective data storage systems 10 by the system classification component 110 could also be used. Additionally, techniques for classifying data storage systems 10 into a group are described in further detail below with respect to FIGS. 7-9.

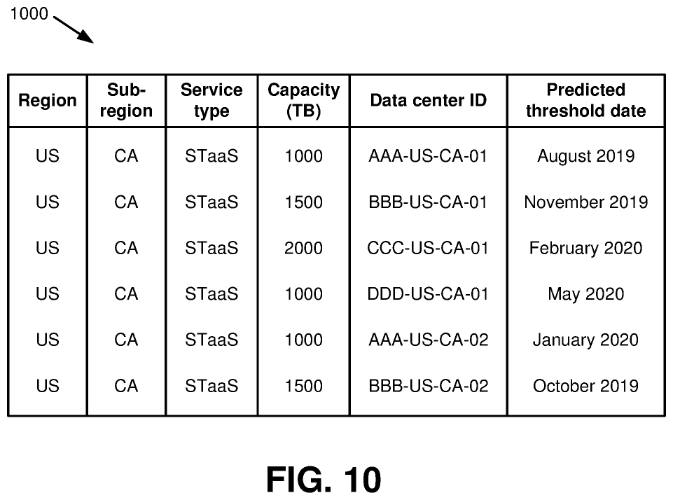

The storage modeling component 120 shown in system 100 can model respective predicted available storage capacities of the data storage systems 10 assigned to a given group by the system classification component 110 over a first time interval based on storage usage data collected from the data storage systems 10 of the group over a second time interval that is before the first time interval, and/or other suitable data. Stated another way, based on storage usage data collected from a data storage system 10 during a present or past time period, the storage modeling component 120 can predict changes to the storage capacity of the data storage system 10 over a defined time period in the future. Techniques that can be employed by the storage modeling component 120 in this manner are described in further detail below with respect to FIGS. 7 and 10. In an implementation, the above described operations of the storage modeling component 120 can result in storage capacity model data representative of a storage capacity model as generated for the respective data storage systems 10 of a system group as defined by the system classification component 110.

The expansion scheduling component 130 shown in system 100 can generate storage expansion schedule data representative of a storage expansion schedule, e.g., a schedule applicable to installing new storage devices at the data storage systems 10 of the system group defined by the system classification component 110, by correlating the storage capacity model data provided by the storage modeling component 120 to manufacturing schedule data representative of a manufacturing schedule for the new storage devices as received from a manufacturing system 20.

In addition to the manufacturing schedule data, the expansion scheduling component 130 can further generate maintenance schedule data representative of defined maintenance schedules for the data storage systems 10 of a given system group, e.g., as received from those data storage systems 10. This maintenance schedule data can then be utilized by the expansion scheduling component 130 as an additional data set to be correlated with the storage capacity model data in producing the storage expansion schedule data and/or altering existing storage expansion schedule data.

By utilizing the system classification component 110, storage modeling component, and expansion scheduling component 130 as described above, production of new storage devices can leverage bulk manufacturing, resulting in reductions to manufacturing and shipping costs. Additionally, shipping windows can be configured to avoid both early delivery and delayed delivery of storage devices, both of which could result in diminished user experience.

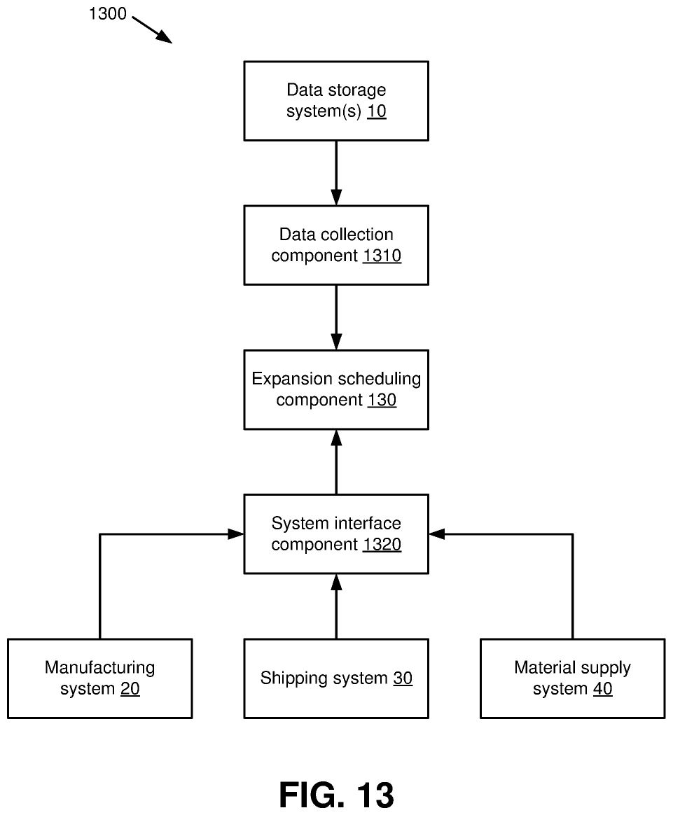

In an implementation, the manufacturing system 20 can be associated with a manufacturing facility that produces the storage devices to be added to the respective data storage systems 10. Communication schemes that can be utilized for receiving and processing data from the data storage systems 10 and/or manufacturing system 20 are described in further detail below with respect to FIG. 13.

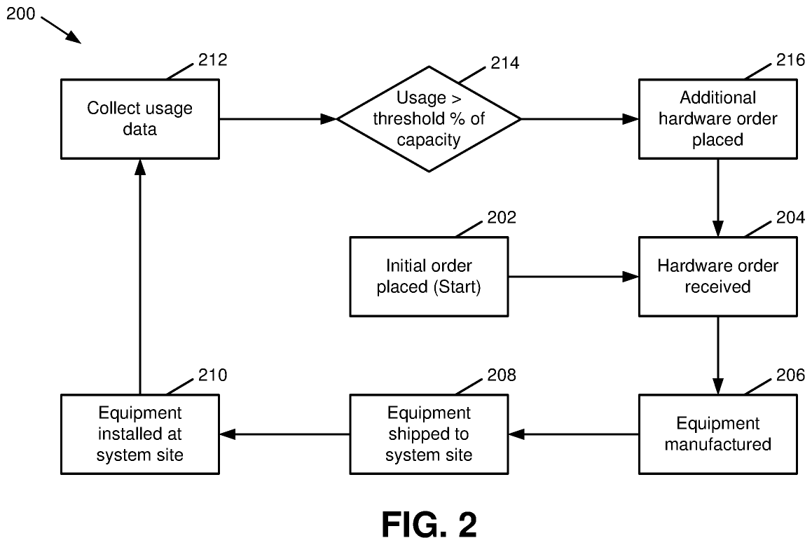

With reference now to FIG. 2, a diagram 200 depicting an example operational flow for maintaining hardware provided as a service in accordance with various implementations described herein is illustrated. It is noted, however, that the process depicted in diagram 200 is merely one example implementation of a HWaaS model and that other implementations could also be used.

The operational flow shown in diagram 200 begins at 202, in which an initial order is placed (e.g., by a customer or other requesting entity) for on-premises hardware to be provided as a service, e.g., according to a contract including a billing agreement. While various examples provided herein relate to data storage hardware specifically, it is noted that the model illustrated by diagram 200 could be applied to any suitable type of computing hardware. Further, the model shown by diagram 200 could be applied to other aaS models, such as infrastructure as a service (IaaS) and/or other such models.

The initial hardware order placed at 202 is received at 204, e.g., by a private/hybrid cloud services provider. The equipment specified in the order can be manufactured at 206, and the manufactured equipment can be shipped to the desired system site (e.g., a system site operated by the customer associated with the initial order at 202) at 208. At 210, the equipment can be installed at the system site and connected to existing network infrastructure, e.g., a local area network (LAN) associated with the system site. Once the equipment specified in the initial order is installed and connected at 210, service can begin, e.g., pursuant to the contract specified at 202.

At 212, the service provider can collect usage data associated with the managed hardware provided to the system site at 210. If the service agreement for a given system site provides for billing based on usage, this usage data can be utilized to determine an amount to bill the local system operator, e.g., per their contract. Additionally, the usage data collected at 212 can be utilized to provide continuity of service for the managed hardware. For instance, at 214, the cloud service provider can determine whether a given system is utilizing more than a threshold amount of its storage capacity. If so, the cloud service provider can infer that the system is likely to run out of storage within a defined future time interval. As a result, the cloud service provider can place an additional hardware order 216, which can then be manufactured, shipped, and installed as described above with respect to 204-210.

The process depicted by diagram 200 can provide the experience of having unlimited storage capacity using finite storage devices by manufacturing and shipping storage capacity periodically in an intelligent manner before a given system reaches full capacity. For instance, whenever a specific threshold is crossed (e.g., 80% of the full storage capacity of the hardware present at the system site), an additional hardware order can be initiated, manufactured, shipped, and deployed as noted above.

Referring now to FIG. 3, a diagram 300 depicting respective supply chain systems associated with respective private cloud systems in accordance with various implementations described herein is provided. As shown in diagram 300, respective system sites can be grouped by geographical region, and hardware orders associated with each of the system sites from each of the regions (e.g., as described above with respect to FIG. 2) can initially be received by an order management system. The order management system can provide relevant order information to a fulfilment system, which can then direct respective hardware orders to fulfilment locations in the associated geographical regions. The fulfilment locations in each region can interface with respective suppliers and shipping services in their respective regions to facilitate the manufacturing and shipping of new hardware to the system sites for which the hardware was ordered.

Due to the expense associated with manufacturing and shipping large amounts of storage capacity, it is desirable to initially deploy only the optimal capacity for a given system site with minimum manufacturing and shipping cost and subsequently add additional hardware on an as-needed basis based on observed system usage. For instance, just-in-time manufacturing can be utilized to produce and ship only the storage devices that are associated with optimal system operation. In doing so, a local system operator can have effectively unlimited storage capacity based on incremental expansion.

In an implementation, usage monitoring can be performed manually, e.g., by checking the utilization of deployed infrastructure for a given system and triggering an additional hardware request when the manual monitoring indicates a threshold has been crossed. However, manual monitoring can result in inefficient and/or delayed storage expansion. By way of the example shown in diagram 300, if a total of six system sites in two separate geographical regions have triggered hardware orders between a date range between dates D1 and D2, this can result in six separate manufacturing and shipping requests to be executed, which increases the cost of manufacturing and shipping.

The above manufacturing and shipping cost issues can be exacerbated if the amount of additional hardware to be manufactured and shipped is relatively small. For instance, table 400 in FIG. 4 illustrates four example data centers having associated hardware orders. If a given hardware order specifies less than a given number of additional storage devices, e.g., three devices for data center DC1 and two devices for data center DC4 as shown in table 400, the relative cost of fulfilling said orders can increase, e.g., due to the inability to leverage economy of scale.

As additionally shown by table 402 in FIG. 4, if the date range D1-D2 for a given group of hardware orders is sufficiently small, the resulting burst of orders can cause overload in manufacturing and/or delay in delivery, which can result in degraded service for the associated systems or even unplanned downtime at said systems if full storage capacity is reached before additional storage devices are installed.

The issues illustrated by tables 400, 402 in FIG. 4 can grow in proportion to the number of systems managed by a cloud service provider. For a cloud service provider that manages hundreds or thousands of individual systems, these issues can grow to the point where manual mitigation of these issues, e.g., by a human, is not feasible or practical. Additionally, given the nature and scope of usage data associated with a very large number of managed systems combined with independent manufacturing, shipping, and maintenance windows associated with respective entities along the supply chain, a human user cannot determine and/or extrapolate trends in the usage data or produce an efficient system expansion schedule in a useful or reasonable timeframe.

Accordingly, various implementations herein enable an intelligent and automatic determination of global scheduling information for system hardware, including the quantities of each product to be manufactured and the optimal manufacturing window(s) for said products, considering storage consumption, manufacturing cost, shipping modes and routes, supplier readiness, system site readiness, and/or other factors, to provide effectively unlimited storage scaling with optimal cost.

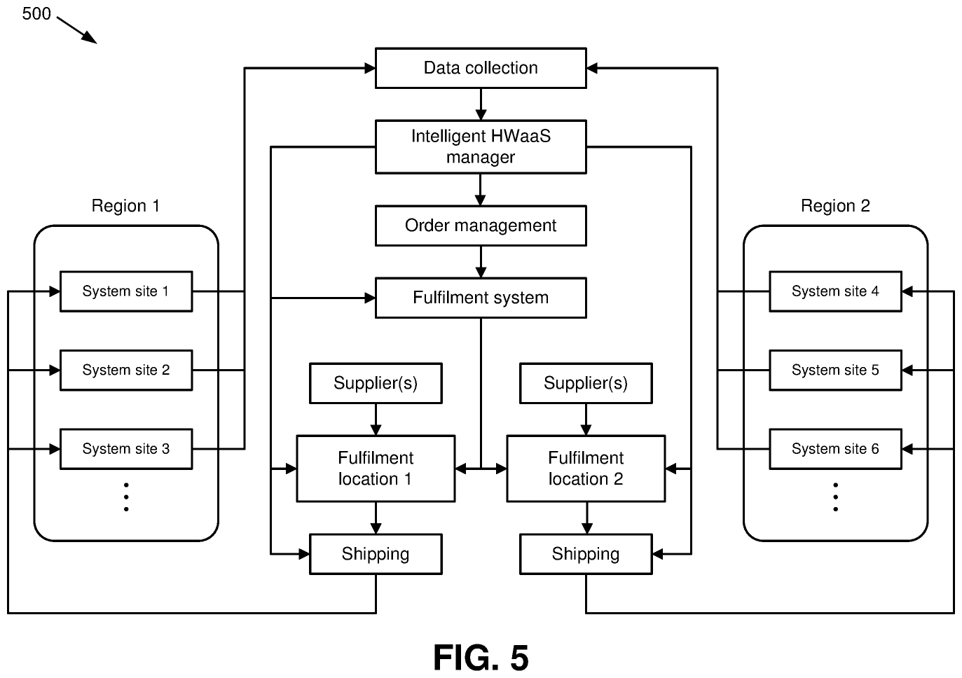

In an implementation as shown by diagram 500 in FIG. 5, a data collection module and an intelligent HWaaS manager can be added to the supply chain depicted by diagram 300 in FIG. 3 to improve manufacturing and shipping management for respective system sites located in different regions. As shown by diagram 500, system usage/consumption and install base data can be provided from the respective system sites to the data collection module, which can then provide said data to the intelligent HWaaS manager Among other functions, the intelligent HWaaS manager can be used to optimize and consolidate orders provided to respective suppliers and/or shippers, thereby reducing costs associated with providing additional storage capacity to the respective system sites.

In an implementation, the data collection module and the intelligent HWaaS manager shown in diagram 500 can incorporate some or all of the functionality of the system classification component 110, storage modeling component 120, and expansion scheduling component 130 as described above with respect to FIG. 1. By leveraging the functionality of components 110, 120, 130, a cloud services provider can facilitate manufacturing and shipping of devices to respective system sites, as well as adding said devices to the existing data center infrastructure at the respective shipping sites to provide functionally unlimited storage capacity for system usage in a cost effective manner.

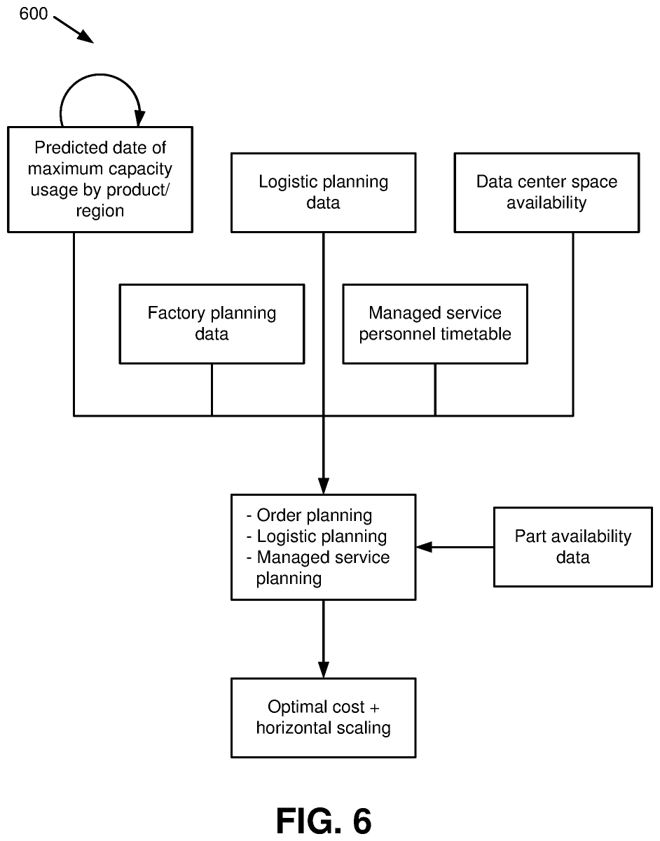

Turning now to FIG. 6, and with further reference to FIG. 1, diagram 600 illustrates various factors that can be applied by system 100 to provide efficient horizontal scaling for respective managed systems. As shown in diagram 600, factors that can be leveraged by system 100 can include, but are not limited to, the following:

1) The predicted date (and/or time) that a given system will reach its maximum storage capacity, e.g., based on modeling the utilized storage capacity against a threshold level. This factor can, in turn, be utilized to further determine which device(s) to manufacture, as well as when said device(s) should be ready for system integration. As further shown by diagram 600, this factor can be periodically updated, e.g., as usage of a given system changes over time.

2) Factory planning data, such as the anticipated plan for a given factory for a given period of time (e.g., the next 3 months). This factor can, in turn, determine where (e.g., at which facility) and when to manufacture given devices in order to reduce the time and cost associated with manufacturing the devices, as manufacturers can vary in availability over time due to their order load and/or other factors.

3) Logistic planning data, such as a summary of logistic plans for respective shippers for a given period of time (e.g., the next 3 months). From this data, a shipment strategy for given devices can be constructed that optimizes transport costs. Additionally, logistic planning data can be used to facilitate regional shipments, e.g., grouping multiple shipments directed to a given region together to facilitate reduced costs as well as increased efficiency of local service personnel.

4) A timetable for managed service personnel, e.g., local service personnel affiliated with the cloud service provider, to execute the work associated with installing new equipment at a given system site. Managed service personnel availability

5) Data representative of an approximate deployment downtime schedule at a given system site over a time window (e.g., over the next two months, etc.) for installation. In an implementation, these data can also include data relating to the time taken for adequate physical storage space for new equipment to be allocated for a shipment of the hardware. It is noted that considering physical storage space availability at a system site can be desirable in order to prevent a shipment of new equipment from being scheduled at a time in which there is no available physical space at the system site, which can lead to additional storage and/or other costs.

6) Data representative of the availability of raw materials and/or parts used in the manufacturing of new storage devices. This factor can, in turn, facilitate refinement of manufacturing windows for a given batch of equipment according to the supplies on hand at a given manufacturer. It is noted that this factor is illustrated separately in diagram 600 from the other factors since material availability data can be provided by sources, such as a manufacturing or supplier system, that are distinct from those that provide data relating to the other factors.

In addition to the factors and data shown in diagram 600, other factors could also be considered. As further shown by diagram 600, the various factors as described above, and/or other information, can be utilized by system 100 to perform planning for equipment orders as well as associated logistics and managed service personnel scheduling according to implementations described herein, resulting in improved cost effectiveness and more efficient horizontal scaling.

Referring now to FIG. 7, a functional block diagram depicting an example model 700 that can be utilized for managing hardware for private or hybrid cloud systems in accordance with various implementations described herein is illustrated. As shown in FIG. 7, one or more data centers 710, 712, 714 can provide usage data 720 to the model 700, e.g., automatically pursuant to a data collection policy put in place by a cloud services provider. While three data centers 710, 712, 714 are illustrated in FIG. 7 for purposes of illustration, it is noted that usage data 720 could be collected from any suitable amount of data centers, including one data center or more data centers, in a similar manner to that described here.

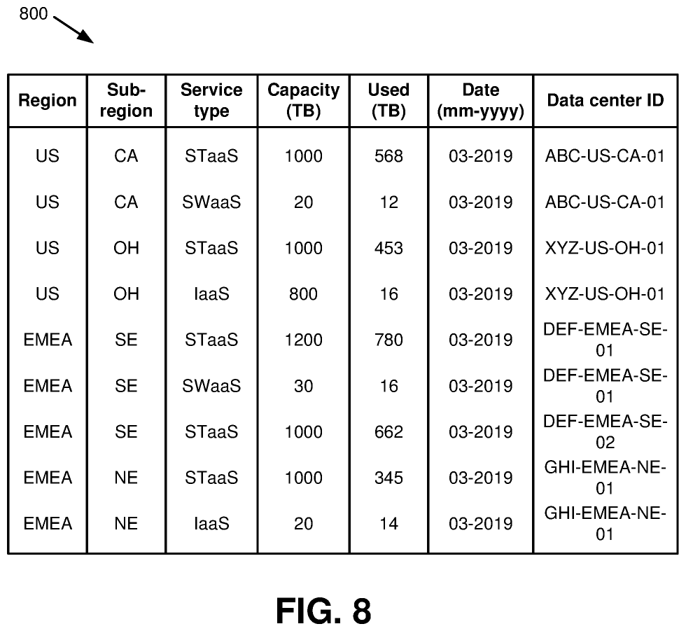

In an implementation, usage data 720 collected from respective data centers 710, 712, 714 can be arranged in a data structure, such as that shown by diagram 800 in FIG. 8. While the data in diagram 800 are arranged in a tabular format for illustrative purposes, it is noted that usage data 720 can be stored and/or utilized in any format suitable for interpretation by a computing system.

As further shown in diagram 800, usage data 720 associated with data centers 710, 712, 714 can include information regarding the geographical location of a given data center, here the region in which a data center is located (e.g., US for the United States, EMEA for Europe, the Middle East, and Africa, etc.) and a sub-region of that region (e.g., state designators for the US region, directional region designators for the EMEA region, etc.). While not shown in diagram 800, additional information regarding the location of a given data center could also be included.

Usage data 720 for a given data center as shown in diagram 800 can further include the type of service(s) being provided to that data center. The example data shown in diagram 800 includes usage data 720 for storage as a service (STaaS), software as a service (SWaaS), and infrastructure as a service (IaaS) deployments. Other service types and/or designations could also be used.

The usage data 720 shown in diagram 800 further includes storage capacity and usage information for each data center and service type, e.g., as given in terabytes (TB). While not shown in diagram 800, other usage metrics could also be provided, such as average memory usage, processor cycle usage, and/or other metrics. Further, respective entries of the usage data 720 shown in diagram 800 conclude with a date associated with the usage data and a unique identifier for each data center.

Returning to FIG. 7, usage data 720 as described above can be processed (e.g., by the system classification component 110 of system 100) at 730 by running a classification algorithm on the usage data based on products indicated in the usage data 720, usage patterns indicated by the usage data 720, and/or other data such as data center locations or the like. In an implementation, classification can be performed at 730 via a tiered approach. For instance, respective data centers can initially be classified based on region and sub-region, and then data centers within each sub-region can further be classified based on product types, product identities, data center identifiers, and/or other properties. This tiered classification approach can facilitate improved efficiency in order planning, e.g., by enabling shipping plans to be grouped by sub-region and manufacturing plans to be grouped by parts and/or products utilized, among other categories.

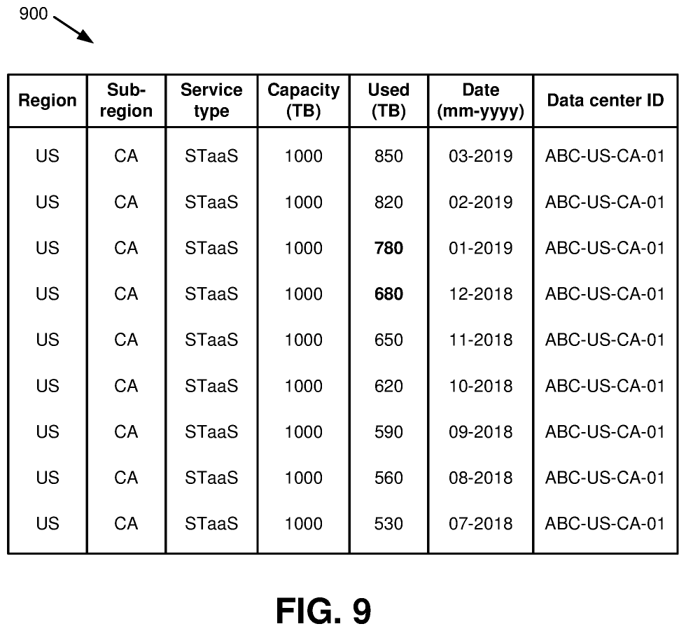

Next, at 732, a statistical model, such as a Bayesian model or the like, can be applied to usage data 720 (e.g., by the storage modeling component 120 of system 100) for respective system categories as determined via the classification algorithm at 730. In an implementation, the statistical model applied at 732 can account for differences in consumption patterns associated with different service types by first assembling historical usage data for a given data center. Diagram 900 in FIG. 9 illustrates example historical data that can be assembled for application to the statistical model at 732 for a given service type as employed by a given data center. It is noted that the example data shown in diagram 900 is merely an example of data that could be utilized for illustrative purposes, and that additional data could be utilized, e.g., in scope or in time, in addition to that shown by diagram 900.

In an implementation, the statistical model utilized at 732 can apply smoothing and/or other pre-processing operations to a set of historical data. From this pre-processed data, and/or from raw historical data, the statistical model can predict future usage patterns based on past usage as provided in the historical data.

The statistical model can additionally account for various factors that can cause variance in system usage over time. By way of example, the model can factor in seasonality in the event that a data center's usage patterns vary on a seasonal basis. For instance, as shown via bold numbers in diagram 900, storage use associated with a data center can be higher over one portion of a year as compared to a typical consumption rate for the remainder of the year. This can occur, e.g., in the case of a retailer that experiences higher sales volume at the end of the year than at other points in the year. Additionally, the statistical model can identify and incorporate other factors, such as holiday schedules, system maintenance windows, or the like, that can impact usage of managed system resources over time.

Next, at 734, the usage data predicted by the statistical model at 732 for a service at a given data center can be compared to an allocated amount of capacity for that service to determine whether the allocated capacity will be surpassed in an upcoming time interval, e.g., within the next six months and/or another interval. By way of example, based on a statistical model as applied to the usage data shown in diagram 900, it can be determined at 734 that the system represented by the usage data will exceed their allocated storage space in August 2019.

From statistical models and capacity comparisons performed at 732 and 734, respectively, for a group of data centers, a table or other data structure can be generated and populated (e.g., by the expansion scheduling component 130 of system 100) with optimal, staggered, and consolidated fulfilment orders for respective products by region. In an implementation, a data structure that can be created at 736 can initially be formatted as shown by diagram 1000 in FIG. 10. As shown by diagram 1000, respective systems of a common region, sub-region, and system type can be arranged by the predicted date at which said systems will exceed their respective storage capacities. From this initial data, adjustments can be made based on maintenance windows, manufacturing and shipping schedules, and/or other factors, resulting in an optimized order schedule for the systems represented in the table.

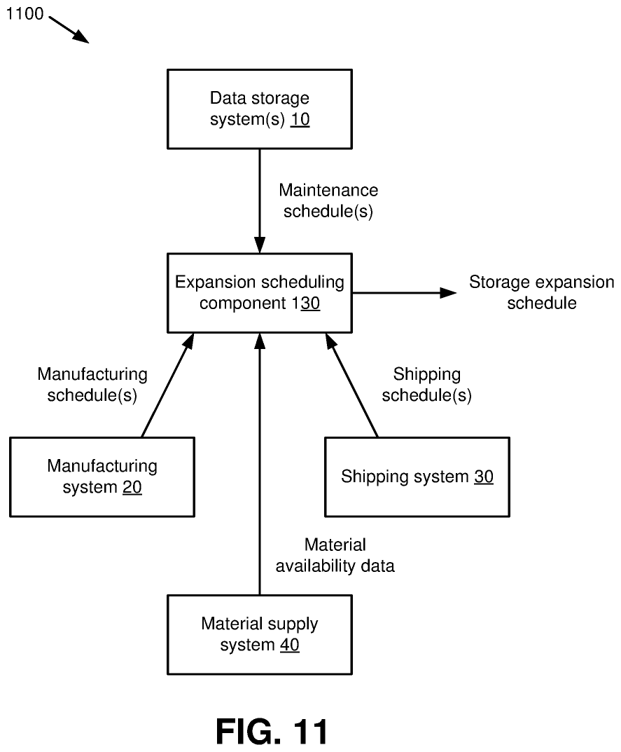

Turning to FIG. 11, a block diagram of a system 1100 that facilitates generation of a storage expansion schedule based on shipping schedule data in accordance with various implementations described herein is illustrated. Repetitive description of like elements employed in other embodiments described herein is omitted for brevity. As shown in FIG. 11, the expansion scheduling component 130 can generate storage expansion schedule data by correlating storage capacity model data with maintenance schedule data collected from respective managed data storage systems 10 and manufacturing schedule data obtained from a manufacturing system 20, e.g., as described above with respect to FIG. 1. In addition, the expansion scheduling component 130 can generate storage expansion schedule data by further correlating the storage capacity model data with shipping schedule data representative of a shipping schedule (e.g., for a given geographical region) as received from a shipping system 30, material availability data as received from a material supply system 40, and/or other suitable information. Usage of shipping schedule data in this manner can result in reduction to shipping costs associated with various devices associated with the storage expansion schedule data, e.g., as described herein.

While not shown in FIG. 11, the expansion scheduling component 130 as shown in system 1100 can additionally correlate storage capacity model data with independent scheduling data received from multiple different data storage systems 10, manufacturing systems 20, shipping systems 30, material supply systems 40, or other sources. For instance, the expansion scheduling component 130 can generate storage expansion schedule data by correlating the storage capacity model data to first manufacturing schedule data representative of a manufacturing schedule for a first manufacturing system 20 as well as at least second manufacturing schedule data representative of manufacturing schedules for at least a second manufacturing system 20.

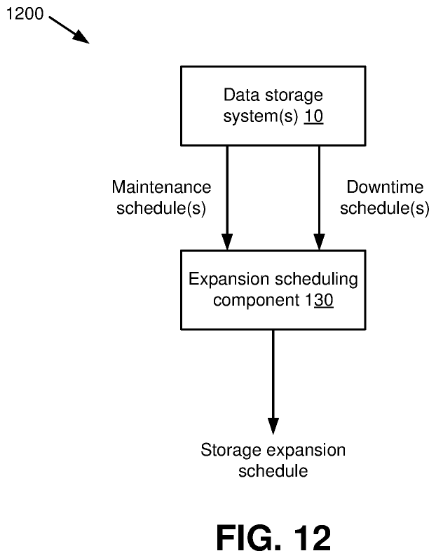

Referring now to FIG. 12, a block diagram of a system 1200 that facilitates generation of a storage expansion schedule based on system downtime schedule data in accordance with various implementations described herein is illustrated. Repetitive description of like elements employed in other embodiments described herein is omitted for brevity. As shown in FIG. 12, the expansion scheduling component 130 of system 1200 can receive downtime schedule data representative of system downtime schedules for respective data storage systems 10, e.g., data storage systems 10 in a system group designated by the system classification component 110. The system downtime schedule data can be received along with other types of data from the data storage systems 10, such as maintenance schedule data, usage or consumption data, or the like. In an implementation, the expansion scheduling component 130 can generate storage expansion schedule data, or modify existing storage expansion schedule data, based on the system downtime schedules indicated in received downtime schedule data.

Turning to FIG. 13, a block diagram of a system 1300 that facilitates collection of data pertaining to scheduling addition of storage devices to a data storage system in accordance with various implementations described herein is illustrated. Repetitive description of like elements employed in other embodiments described herein is omitted for brevity. As shown in FIG. 13, system 1300 includes a data collection component 1310 that can collect data, such as storage usage data, maintenance schedule data, etc., from respective associated data storage systems 10. In an implementation, the data collection component 1310 can obtain relevant data from a data storage system 10 directly from hardware of the data storage system 10, e.g., according to a data collection policy and/or other policies or procedures as specified in a service agreement between an operator of the data storage system 10 and a cloud service provider or via other means for providing affirmative consent for data collection.

As further shown by FIG. 13, system 1300 also includes a system interface component 1320 that can obtain data from one or more associated systems other than the managed data storage systems 10. Data that can be received by the system interface component 1320 can include, but is not limited to, manufacturing schedule data from a manufacturing system 20, shipping schedule data from a shipping system 30, material availability data from a material supply system 40, and/or any other suitable types of information. In an implementation, data can be provided to the system interface component 1320 from one or more systems 20, 30, 40 via an application programming interface (API) and/or any other techniques by which data interpretable by the expansion scheduling component 130 can be provided to system 1300.

Returning again to FIG. 1, system 100 can facilitate the generation of a storage expansion schedule for respective data storage systems 10 to account for factors that can affect the cost of manufacturing and shipment of storage devices. These factors can include number of orders for a given type of system node or other equipment can be considered, as more orders for a particular type of equipment can reduce costs due to economy of scale. In addition, orders in some cases can be batched to reach a minimum order size specified by a given manufacturer and/or other limitations. The factors that can be considered by system 100 can further include the extent of low-cost factory availability. The factors can additionally include the shipment mode to be utilized for a given equipment shipment, as shipments by sea are less expensive than other types of freight (air, land) but take additional time to complete. Similarly, the factors can include whether equipment associated with a given order can be packaged as a single shipment, e.g., as opposed to multiple shipments which can increase costs.

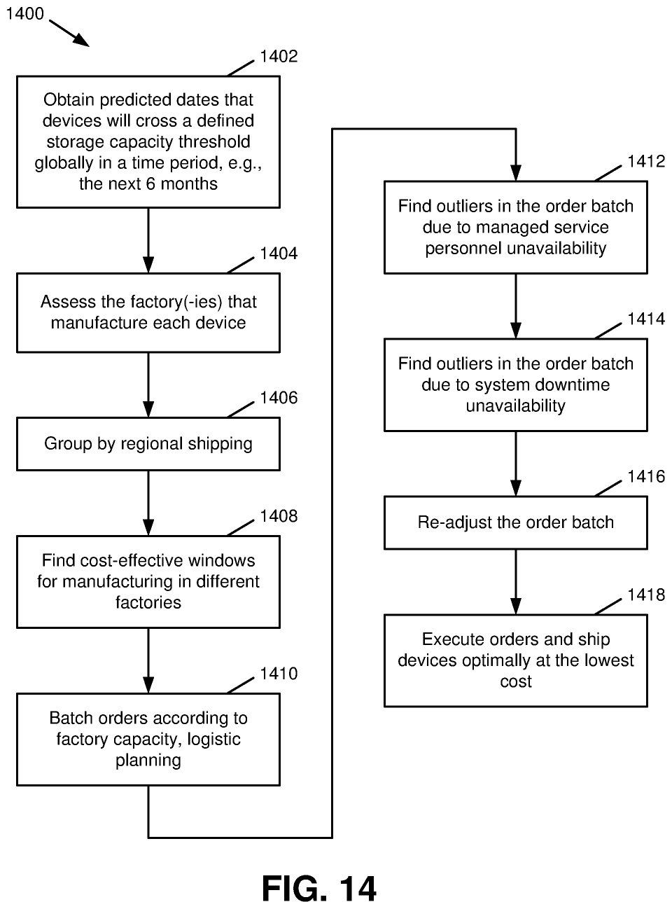

With reference now to FIG. 14, a flow diagram of a method 1400 that facilitates intelligent hardware delivery for on-premises hardware as a service in accordance with various implementations described herein is illustrated. At 1402, the predicted dates that respective devices (e.g., devices associated with data storage systems 10) will cross a defined storage capacity threshold (limit) can be determined, e.g., by the storage modeling component 120 of system 100. In an implementation, the predicted dates can be determined via a Bayesian prediction model based on respective variables and factors as described above with respect to FIG. 7.

At 1404, the factories that manufacture respective devices considered at 1402 can be assessed. For instance, based on system classifications as performed by the system classification component 110 of system 100, the factories that manufacture different categories of devices can be considered together for the respective device categories. Similarly, at 1406, respective data storage systems and their individual devices can be grouped according to geographical region for shipping purposes.

At 1408, cost-effective windows for manufacturing devices (e.g., devices associated with new equipment orders) in different factories can be determined, e.g., with respect to individual factory plans of different factories, manufacturing rates, raw material supply (e.g., as indicated by a material requisition plan and/or other sources), and/or other factors. Based on the time windows determined at 1408, respective orders can be batched at 1410 according to factory capacity, shipping routes and/or other logistic planning, and/or other criteria.

In an implementation, the order batches generated at 1410 can be associated with predicted delivery dates for the respective order batches at their associated system sites. Subsequently, any outliers in a given order batch due to unavailability of local managed service personnel for installing and connecting the ordered hardware can be determined at 1412. Similarly, outlying orders in a batch due to unavailability of system downtime at a given system site can be determined at 1414.

At 1416, based on the outlying orders found at 1412 and 1414, as well as other factors such as unavailability of raw materials for manufacturing ordered devices, the associated order batch can be adjusted to account for the outliers. In an implementation, after adjusting the order batch as shown at 1416, the order batch can again be checked for outliers as described above at 1412 and 1414, and the actions depicted at 1412-1416 can be repeated until the order batch is normalized. Once the order batch has been prepared and normalized at 1416, method 1400 can conclude at 1418 by executing the orders and shipping the corresponding devices to their respective system sites at an optimal cost.

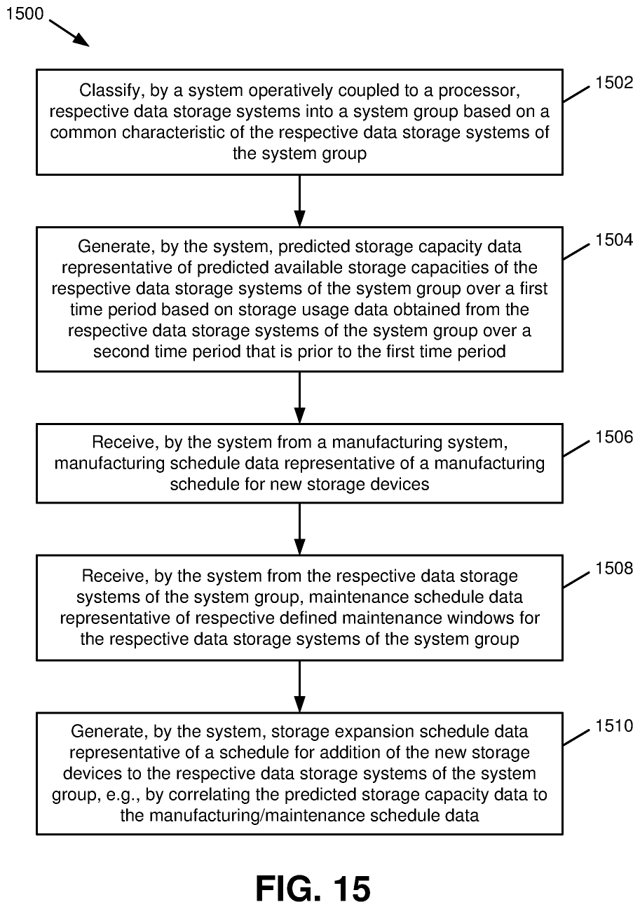

Referring next to FIG. 15, a flow diagram of another method 1500 that facilitates intelligent hardware delivery for on-premises hardware as a service in accordance with various implementations described herein is illustrated. At 1502, a system operatively coupled to a processor can classify (e.g., by a system classification component 110) respective data storage systems (e.g., data storage systems 10) into a system group based on a common characteristic of the respective data storage systems of the system group.

At 1504, the system can generate (e.g., by a storage modeling component 120) predicted storage capacity data representative of predicted available storage capacities of the data storage systems of the system group created at 1502 over a first (future) time period based on storage usage data collected from the respective data storage systems of the system group created at 1502 over a second (past) time period that is before the first time period.

At 1506, the system can receive (e.g., by an expansion scheduling component 130 via a system interface component 1320), from a manufacturing system (e.g., a manufacturing system 20), manufacturing schedule data representative of a manufacturing schedule for new storage devices.

At 1508, the system can receive (e.g., by the expansion scheduling component 130 via a data collection component 1310), from the data storage systems of the system group, maintenance schedule data representative of respective defined maintenance windows for the respective data storage systems of the system group.

At 1510, the system can generate (e.g., by the expansion scheduling component 130) storage expansion schedule data representative of a schedule for addition of the new storage devices to the respective data storage systems of the system group. In an implementation, the storage expansion schedule data can be generated at 1510 by correlating the predicted storage capacity data generated at 1504 to the manufacturing schedule data received at 1506 and the maintenance schedule data received at 1506.

FIGS. 14-15 as described above illustrate methods in accordance with certain implementations of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain implementations of this disclosure.

In order to provide additional context for various embodiments described herein, FIG. 16 and the following discussion are intended to provide a brief, general description of a suitable computing environment 1600 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 16, the example environment 1600 for implementing various embodiments of the implementations described herein includes a computer 1602, the computer 1602 including a processing unit 1604, a system memory 1606 and a system bus 1608. The system bus 1608 couples system components including, but not limited to, the system memory 1606 to the processing unit 1604. The processing unit 1604 can be any of various commercially available processors. Dual microprocessors and other multi-processor architectures can also be employed as the processing unit 1604.

The system bus 1608 can be any of several types of bus structure that can further interconnect to a memory bus (with or without a memory controller), a peripheral bus, and a local bus using any of a variety of commercially available bus architectures. The system memory 1606 includes ROM 1610 and RAM 1612. A basic input/output system (BIOS) can be stored in a non-volatile memory such as ROM, erasable programmable read only memory (EPROM), EEPROM, which BIOS contains the basic routines that help to transfer information between elements within the computer 1602, such as during startup. The RAM 1612 can also include a high-speed RAM such as static RAM for caching data.

The computer 1602 further includes an internal hard disk drive (HDD) 1614 (e.g., EIDE, SATA), one or more external storage devices 1616 (e.g., a magnetic floppy disk drive (FDD), a memory stick or flash drive reader, a memory card reader, etc.) and an optical disk drive 1620 (e.g., which can read or write from a CD-ROM disc, a DVD, a BD, etc.). While the internal HDD 1614 is illustrated as located within the computer 1602, the internal HDD 1614 can also be configured for external use in a suitable chassis (not shown). Additionally, while not shown in environment 1600, a solid state drive (SSD) could be used in addition to, or in place of, an HDD 1614. The HDD 1614, external storage device(s) 1616 and optical disk drive 1620 can be connected to the system bus 1608 by an HDD interface 1624, an external storage interface 1626 and an optical drive interface 1628, respectively. The interface 1624 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1602, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1612, including an operating system 1630, one or more application programs 1632, other program modules 1634 and program data 1636. All or portions of the operating system, applications, modules, and/or data can also be cached in the RAM 1612. The systems and methods described herein can be implemented utilizing various commercially available operating systems or combinations of operating systems.

Computer 1602 can optionally comprise emulation technologies. For example, a hypervisor (not shown) or other intermediary can emulate a hardware environment for operating system 1630, and the emulated hardware can optionally be different from the hardware illustrated in FIG. 16. In such an embodiment, operating system 1630 can comprise one virtual machine (VM) of multiple VMs hosted at computer 1602. Furthermore, operating system 1630 can provide runtime environments, such as the Java runtime environment or the .NET framework, for applications 1632. Runtime environments are consistent execution environments that allow applications 1632 to run on any operating system that includes the runtime environment. Similarly, operating system 1630 can support containers, and applications 1632 can be in the form of containers, which are lightweight, standalone, executable packages of software that include, e.g., code, runtime, system tools, system libraries and settings for an application.

Further, computer 1602 can be enable with a security module, such as a trusted processing module (TPM). For instance with a TPM, boot components hash next in time boot components, and wait for a match of results to secured values, before loading a next boot component. This process can take place at any layer in the code execution stack of computer 1602, e.g., applied at the application execution level or at the operating system (OS) kernel level, thereby enabling security at any level of code execution.

A user can enter commands and information into the computer 1602 through one or more wired/wireless input devices, e.g., a keyboard 1638, a touch screen 1640, and a pointing device, such as a mouse 1642. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1604 through an input device interface 1644 that can be coupled to the system bus 1608, but can be connected by other interfaces, such as a parallel port, an IEEE 1394 serial port, a game port, a USB port, an IR interface, a BLUETOOTH® interface, etc.

A monitor 1646 or other type of display device can be also connected to the system bus 1608 via an interface, such as a video adapter 1648. In addition to the monitor 1646, a computer typically includes other peripheral output devices (not shown), such as speakers, printers, etc.

The computer 1602 can operate in a networked environment using logical connections via wired and/or wireless communications to one or more remote computers, such as a remote computer(s) 1650. The remote computer(s) 1650 can be a workstation, a server computer, a router, a personal computer, portable computer, microprocessor-based entertainment appliance, a peer device or other common network node, and typically includes many or all of the elements described relative to the computer 1602, although, for purposes of brevity, only a memory/storage device 1652 is illustrated. The logical connections depicted include wired/wireless connectivity to a local area network (LAN) 1654 and/or larger networks, e.g., a wide area network (WAN) 1656. Such LAN and WAN networking environments are commonplace in offices and companies, and facilitate enterprise-wide computer networks, such as intranets, all of which can connect to a global communications network, e.g., the Internet.

When used in a LAN networking environment, the computer 1602 can be connected to the local network 1654 through a wired and/or wireless communication network interface or adapter 1658. The adapter 1658 can facilitate wired or wireless communication to the LAN 1654, which can also include a wireless access point (AP) disposed thereon for communicating with the adapter 1658 in a wireless mode.

When used in a WAN networking environment, the computer 1602 can include a modem 1660 or can be connected to a communications server on the WAN 1656 via other means for establishing communications over the WAN 1656, such as by way of the Internet. The modem 1660, which can be internal or external and a wired or wireless device, can be connected to the system bus 1608 via the input device interface 1644. In a networked environment, program modules depicted relative to the computer 1602 or portions thereof, can be stored in the remote memory/storage device 1652. It will be appreciated that the network connections shown are example and other means of establishing a communications link between the computers can be used.

When used in either a LAN or WAN networking environment, the computer 1602 can access cloud storage systems or other network-based storage systems in addition to, or in place of, external storage devices 1616 as described above. Generally, a connection between the computer 1602 and a cloud storage system can be established over a LAN 1654 or WAN 1656 e.g., by the adapter 1658 or modem 1660, respectively. Upon connecting the computer 1602 to an associated cloud storage system, the external storage interface 1626 can, with the aid of the adapter 1658 and/or modem 1660, manage storage provided by the cloud storage system as it would other types of external storage. For instance, the external storage interface 1626 can be configured to provide access to cloud storage sources as if those sources were physically connected to the computer 1602.

The computer 1602 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory that stores executable components; and
a processor that executes the executable components stored in the memory, wherein the executable components comprise:
a system classification component that classifies respective data storage systems into a group of data storage systems based on a common characteristic of the respective data storage systems of the group of data storage systems, resulting in grouped data storage systems;
a storage modeling component that models respective predicted available storage capacities of the grouped data storage systems over a first time interval based on storage usage data collected from the grouped data storage systems over a second time interval that is before the first time interval, resulting in storage capacity model data representative of a storage capacity model for the grouped data storage systems applicable to the first time interval; and
an expansion scheduling component that generates storage expansion schedule data representative of a schedule applicable to installing new storage devices at the grouped data storage systems by correlating the storage capacity model data to manufacturing schedule data representative of a manufacturing schedule for the new storage devices as received from a manufacturing system, and generates maintenance schedule data representative of respective defined maintenance schedules for the grouped data storage systems as received from the grouped data storage systems.

2. The system of claim 1, wherein the common characteristic of the grouped data storage systems is a geographical region in which the grouped data storage systems are located, resulting in a grouping of demand from a geographical region for a device associated with the grouped data storage systems.

3. The system of claim 2, wherein the expansion scheduling component further generates the storage expansion schedule data by further correlating the storage capacity model data to shipping schedule data representative of a shipping schedule for the geographical region as received from a shipping system, resulting in a reduction to a shipping cost associated with the storage expansion schedule data.

4. The system of claim 1, wherein the common characteristic of the grouped data storage systems is a common feature of the grouped data storage systems, the common feature being selected from a group comprising a hardware feature and a software feature.

5. The system of claim 1, wherein the expansion scheduling component receives downtime schedule data representative of system downtime schedules for the grouped data storage systems and modifies the storage expansion schedule data in response to receiving the downtime schedule data.

6. The system of claim 1, wherein the executable components further comprise:
a system interface component that obtains the manufacturing schedule data from the manufacturing system via an application programming interface.

7. The system of claim 1, wherein the executable components further comprise:
a data collection component that collects at least one of the storage usage data or the maintenance schedule data from the grouped data storage systems according to a data collection policy.

8. The system of claim 1, wherein the expansion scheduling component further generates the storage expansion schedule data by further correlating the storage capacity model data to material availability data as received from a material supply system.

9. The system of claim 1, wherein the manufacturing schedule data is first manufacturing schedule data representative of a first manufacturing schedule for the new storage devices as received from a first manufacturing system, and wherein the expansion scheduling component further generates the storage expansion schedule data by further correlating the storage capacity model data to second manufacturing schedule data representative of a second manufacturing schedule for the new storage devices as received from a second manufacturing system that is different from the first manufacturing system.

10. A method, comprising:
classifying, by a system operatively coupled to a processor, respective data storage systems into a system group based on a common characteristic of the respective data storage systems of the system group;
generating, by the system, predicted storage capacity data representative of respective predicted available storage capacities of the respective data storage systems of the system group over a first time period based on storage usage data obtained from the respective data storage systems of the system group over a second time period that is prior to the first time period;
receiving, by the system from a manufacturing system, manufacturing schedule data representative of a manufacturing schedule for new storage devices;
receiving, by the system from the respective data storage systems of the system group, maintenance schedule data representative of respective defined maintenance windows for the respective data storage systems of the system group; and
generating, by the system, storage expansion schedule data representative of a schedule for addition of the new storage devices to the respective data storage systems of the system group, wherein generating the storage expansion schedule data comprises correlating the predicted storage capacity data to the manufacturing schedule data and the maintenance schedule data.

11. The method of claim 10, wherein the common characteristic of the respective data storage systems of the system group is a geographical region in which the respective data storage systems of the system group are located.

12. The method of claim 11, further comprising:
receiving, by the system from a shipping system, shipping schedule data representative of a shipping schedule associated with the geographical region, wherein generating the storage expansion schedule data further comprises correlating the predicted storage capacity data to the shipping schedule data.

13. The method of claim 10, wherein the common characteristic of the respective data storage systems of the system group is selected from a group comprising a common hardware feature of the respective data storage systems of the system group and a common software feature of the respective data storage systems of the system group.

14. The method of claim 10, wherein receiving the manufacturing schedule data comprises receiving the manufacturing schedule data from the manufacturing system via an application programming interface.

15. The method of claim 10, further comprising:
obtaining, by the system, the storage usage data from the respective data storage systems of the system group according to a data collection policy.

16. A non-transitory machine-readable medium comprising computer executable instructions that, when executed by a processor of a computing system, facilitate performance of operations, the operations comprising:
assigning respective data storage systems to a system group based on a common property of the respective data storage systems;
generating storage availability prediction data representative of predicted available storage capacities of the respective data storage systems over a first time interval based on system usage data obtained from the respective data storage systems over a second time interval that is earlier than the first time interval; and
determining system expansion scheduling data representative of a schedule for installation of additional storage devices at the respective data storage systems based on correlating the storage availability prediction data with manufacturing scheduling data representative of a manufacturing schedule for the additional storage devices from a manufacturing system and maintenance schedule data representative of respective system maintenance schedules for the respective data storage systems.

17. The non-transitory machine-readable medium of claim 16, wherein the common property of the respective data storage systems is a geographical region in which the respective data storage systems are located, and wherein the operations further comprise:
further determining the system expansion scheduling data based on correlating the storage availability prediction data with shipping scheduling data representative of a shipping schedule for the geographical region as received from a shipping system.

18. The non-transitory machine-readable medium of claim 16, wherein the common property of the respective data storage systems is selected from a group comprising a hardware feature of the respective data storage systems and a software feature of the respective data storage systems.

19. The non-transitory machine-readable medium of claim 16, wherein the operations further comprise:
receiving the manufacturing scheduling data from the manufacturing system via an application programming interface.

20. The non-transitory machine-readable medium of claim 16, wherein the operations further comprise:
obtaining the system usage data from the respective data storage systems according to a data collection policy.
